(19) United States
(12) Patent Application Publication
(10) Pub. No.: US 2017/0140869 A1
(43) Pub. Date: May 18, 2017

(54) WORKING UNIT EQUIPPED WITH A DEVICE FOR CONTACTLESS ELECTRICITY TRANSFER AND METHOD FOR CONTACTLESS ELECTRICITY TRANSFER IN A WORKING UNIT

(71) Applicant: I.M.A. INDUSTRIA MACCHINE AUTOMATICHE S.P.A., OZZANO DELL'EMILIA (BOLOGNA) (IT)

(72) Inventors: ALESSANDRA COSTANZO, BOLOGNA (IT); RICCARDO TREVISAN, BOLOGNA (IT); DARIO REA, MONTERENZIO (IT)

(21) Appl. No.: 15/310,308

(22) PCT Filed: May 22, 2015
(86) PCT No.: PCT/IB2015/053767

§ 371 Date: Nov. 10, 2016

(30) Foreign Application Priority Data
May 23, 2014 (IT) BO2014A000304
Sep. 5, 2014 (IT) BO2014A000487

(51) Int. Cl. H01F 38/14; H01F 27/32; H02J 50/05; H01F 27/28; H01F 27/36; H02J 50/10; H01F 27/24; H01F 27/00

(52) U.S. Cl. CPC H01F 38/14; H01F 27/24; H01F 27/323; H01F 27/004; H01F 27/2895; H01F 27/36; H02J 50/10; H02J 50/05

(57) ABSTRACT

Described is a working unit (1) comprising a stationary part (2) and a movable part (3) and a movable working device (4) defining an electrical user device, powered by a stationary electricity supply (5A) through a first contactless electricity supply line (L1), defined by a rotary transformer; the working unit (1) also comprises a control element (12), movable as one with the working device (4) and designed to vary a relative electrical property as a function of a parameter relative to the working device (4); the control element (12) is powered, at least temporarily, independently from the electricity supply of the working device (4).

### TECHNICAL FIELD

This invention relates to a working unit equipped with a device for contactless electricity transfer and method for contactless electricity transfer in a working unit.

The invention relates to the technical field of machinery having working devices powered electrically and movable relative to the corresponding electrical power supplies, which are positioned in a part of the machinery stationary relative to the device itself.

### BACKGROUND ART

In this the field there are many different applications; for example, the device may consist of a welding element, rotary or vibrating, or a servomotor.

In this context, the more commonly used technical solution comprises sliding contacts. The problem of the sliding contacts is that they wear with use, so they are subject to frequent faults, which limit the reliability of the machines in which they are inserted.

An alternative to the sliding electrical contacts consists of contactless electricity transfer systems, based on the principle of electromagnetic induction. In practice, these solutions provide two ferromagnetic cores (that is, half-cores) separated by a gap, on which are wound respective windings; this configuration differs from that of the transformer by the fact that the two cores are in relative motion, in such a way that the movable device to be powered is made integral with the movable core, whilst the electricity supply is integral with the stationary core.

In light of this, the patent document U.S. Pat. No. 3,040,162 describes a rotary welding apparatus, which is powered by a device for contactless electricity transfer consisting of a “rotary transformer”.

Patent documents WO2008156116A1 and U.S. Pat. No. 4,404,559 also describe a “rotary transformer”. Other solutions which use rotary transformers are described in patent documents US2014083623, GB2326756A, U.S. Pat. No. 5,770,936, U.S. Pat. No. 4,749,993A, WO2009033573A1.

Patent documents WO2012163919A2, US2003001456A and US2010158307A1 describe other contactless devices for transferring electricity based on the principal and applied to ultrasonic welding devices.

However, the prior art solutions have some limitations, concerning the problems linked with the need to performs a complete and efficient control of the device.

A problem is that of keeping under control a parameter representing the operation of the device (for example, the temperature of a welding apparatus), also when the device is de-energised (preferably, for any time after the device is powered down).

Another problem concerns the electromagnetic pollution, to avoid the risk of interference with the activities of other nearby machines.

Another problem concerns the overall dimensions of the contactless electricity transfer device, which, if relatively high, limits the freedom of design of the machinery.

Another problem concerns the need to provide in the stationary part of the working unit a control signal based on measurements taken (for example, by a sensor) positioned in the movable part of the working unit.

In this context, there is in particular the need to make the device particularly sensitive, but also simple (especially with regard to the movable part of the working unit).

The prior art solutions do not provide satisfactory responses to these requirements and problems. In effect, the prior art solutions do not allow the control of the device to be also continued after the power supply to the device has been interrupted or stopped (which defines a so-called “power” electric user device).

### Aim of the Invention

The aim of this invention is to provide a working unit equipped with a device for contactless electricity transfer and a method for contactless electricity transfer in the working unit, which overcome the drawbacks of the above-mentioned prior art.

According to one aspect, the aim of the present disclosure is to provide a working unit equipped with a device for contactless electricity transfer (and therefore without wear) and a method for contactless electricity transfer in the working unit, which facilitates a complete and effective control of the movable device of the working unit.

A further aim of this disclosure is to provide a working unit equipped with a device for contactless electricity transfer and a method for contactless electricity transfer in the working unit, which has a particularly low impact in terms of electromagnetic pollution.

Another aim of this disclosure is to provide a working unit equipped with a device for contactless electricity transfer with high efficiency and whose overall size is particularly limited.

Another aim of this disclosure is to provide a working unit equipped with a device for contactless electricity transfer which is particularly sensitive and simple in construction (especially concerning the electronics of the movable part of the working unit).

These aims are fully achieved by the working unit and by the method according to the disclosure, as characterised in the appended claims.

More specifically, the working unit according to the disclosure has a stationary part and a part movable relative to the stationary part.

The working unit comprises at least one working device, which is powered electrically and therefore defines an electrical user device; the working device is integral with (that is, included in) the movable part of the working unit.

The device is, in general, any electromechanical apparatus (or even electronic), which requires an electrical power supply to perform a technical function, that is, work within the working unit. For example, the device may be a welder (preferably heated), which is rotary or vibrating, or a servomotor, or a compressor.

The working unit also comprises at least one electricity supply, designed to power the device. The electricity supply is integral with (that is, it is included in) the stationary part of the working unit. Moreover, the working unit comprises a device for contactless electricity transfer.

The electricity transfer device comprises a stationary ferromagnetic core, connected to (included in) the stationary part of the working unit, and a movable ferromagnetic core, connected to (included in) the movable part of the working unit.

Moreover, the electricity transfer device comprises a first winding, wound on the stationary core and connected to the electricity supply, and a second winding, wound on the movable core and connected to the device.

The stationary and movable are cores coupled, in such a way that a first current circulating in the first winding generates by electromagnetic induction a second current in cores second winding; the cores are configured in such a way as to remain coupled with the relative variation of the position of the cores; in other words, the magnetic flow varies irrespective of the variation of the relative position between the cores. For this reason, the electricity transfer device constitutes a contactless electricity supply line of the device.

In light of this, it should be noted that the electricity supply connected to the first winding is configured for generating a variable supply voltage at a predetermined frequency (for example in the order of tens or hundreds of kHz, up to tens of MHz and over).

More specifically, the working unit also comprises, as well as the electricity supply, a further electricity supply.

The working unit comprises a control element, movable as one with the device; the control element is connected to (included in) the movable part of the working unit. The control element is designed to generate (directly or indirectly) a control signal representing at least one parameter relating to the device. For example, the control element is a temperature sensor or a position transducer, or a pressure sensor (or an electronic device of another type, depending on the application).

More specifically, the control element is designed to vary a relative electrical property as a function of a parameter relative to the working device.

The working unit comprises a power supply element, connected electrically to the control element for powering it in the absence of electricity supply dispensed to the working device.

This makes it possible to power the control element even when the device is powered down, making it possible to perform a particularly complete and reliable control, within the working unit. For example, the working unit comprises one or more capacitors (or one or more batteries) which are integral with the movable part and connected to the second winding of the electricity transfer device; in that case, the electricity supply element comprises the capacitor (or plurality of capacitors or batteries).

In this case, when the electricity supply line (defined by the electricity transfer device) is opened and consequently the working device is powered down, the capacitor continues (for a certain time) to dispense current to the control element.

Alternatively, or in addition, the working unit comprises a further contactless electricity supply line, independent of the contactless electricity supply line of the device (defined by the electricity transfer device for powering the device), defining a wireless connection between the control element and the further electricity supply in the stationary part of the working unit. In that case, the control element is powered by the further contactless electricity supply line, so the further contactless electricity supply line constitutes the electricity supply unit.

According to an embodiment, the electricity transfer device comprises a first contactless electricity supply line, for powering the device, and a second further contactless electricity supply line, for powering the control element.

This makes it possible to power the control element without limits of time, in the absence of electricity supply of the working device.

For this reason, the control element has a second contactless electricity supply line dedicated to powering the control element, independently of the device. In other words, the working device is disconnected from the second electricity supply line.

Alternatively, if a single contactless electricity supply line is used, a capacitor (or other elements for accumulating electricity) is inserted in an electricity supply element (positioned in the rotating part of the device) for powering the control element; thus, this electricity supply element is positioned in a branch of electrical connection to the control element, the electricity supply branch excluding the device. In other words, the working device is disconnected from the power supply element.

According to another embodiment, the further (second) contactless electricity supply line comprises:
a third winding, wound on the stationary core (or, alternatively, on a further stationary ferromagnetic core distinct from the stationary core on which the first winding is wound) and connected to a respective electricity supply;
a fourth winding, wound on the movable core (or, alternatively, on a further movable ferromagnetic core distinct from the movable core on which the second winding is wound) and connected to the respective electricity supply.

Thus, in this embodiment, the first and the second contactless electricity supply lines define two separate inductive couplings.

In this case, if the capacitor (or the battery) is present, it can be connected to the fourth winding (as an alternative to or in addition to the second winding).

According to another embodiment, the further electricity supply line is configured to generate a further variable supply voltage at a predetermined frequency different from the frequency of the electricity supply of the device and is connected to the first winding.

According to another embodiment, the further electricity supply line comprises a filter connected to the movable part of the working unit and connected to the second winding, upstream of the control element, for selecting the current generated by the further electricity supply line and supplying it to the control element.

In this embodiment, the first and second contactless electricity supply line use a same inductive coupling.

According to another embodiment, the further contactless electricity supply line comprises at least a stationary winding and a movable winding, operatively facing each other to define a capacitive coupling.

For example, the stationary winding is connected to the further electricity supply, whilst the movable winding is connected to the control element for powering it.

Thus, in this embodiment, the first contactless electricity supply line defines an inductive coupling (for powering the device or, alternatively, the control element) and the second contactless electricity supply line defines a capacitive coupling (for powering the control element or, in this alternative, the device).

According to another aspect of the disclosure, the working unit comprises a system for transmitting (that is, means of transmitting) a signal between the control element and a control unit (or, in general, a processing unit, that is, a processor) integral with the stationary part of the working unit.

In light of this, according to an embodiment, the working unit comprises an optical transmitter connected to the control element in the movable part of the working unit, and an optical receiver in the stationary part of the working unit, the optical transmitter and receiver being coupled through an optical path positioned along an axis unchanging with respect to the relative position of the movable and stationary parts of the working unit.

Alternatively (o in addition), the third and fourth winding are used to transmit a signal from the control element to the stationary part of the working unit.

In another embodiment, the control signal is derived by a processor (associated with the stationary part of the working unit and consisting for example of a processor, that is to say, an electronic card, or by a suitably programmed CPU) designed to receive a signal representing a current absorbed by the control element (and dispensed by the further electricity supply). Thus, the processor is connected to the further electricity supply to receive a control parameter representing a power supply current absorbed by the control element. The processor is programmed to derive the control signal (representing the parameter relating to the working device), as a function of a trend of the control parameter.

In other words, the processor derives the control signal as a function of a disturbance of the current (that is, voltage) for powering the control element, which is due to a variation of an electrical property of the control element, as a function of the parameter relating to the device.

This enables the electronics of the device to be simplified (especially in the movable part).

For example, the control element is a resistive sensor; thus, it defines a variable resistance (as a function of the parameter relating to the working device). The variations in resistance of the resistive sensor are reflected in corresponding variations (which may be seen as a disturbance) of the power supply current of the sensor, as the voltage generated by the further electricity supply has a known trend; in this case, the control parameter may be, for example, a current, a voltage or a power absorbed by the sensor.

This applies, more in general, for other types of sensors or devices defining the control element, for which there is an electrical property to be varied as a function of a parameter relative to the working device.

In light of this, preferably, the wireless electricity transmission device (that is, the working unit) comprises a rectifier (that is, an AC/DC converter) in the movable part of the working unit and inserted in the further contactless electricity supply line, upstream of the control element, which is therefore powered with a direct current.

This increases the sensitivity of the device, in such a way that the variations of the electrical properties of the control element generate a corresponding disturbance of the alternating current (high frequency) generated by the further electricity supply for powering the control element.

It should be noted that the DC/DC converter is electrically connected to the control element and to the electricity supply element for adjusting the output voltage of the electricity supply element to the operating voltage of the control element if these voltages differ significantly, as in the case wherein the electricity supply line is not a very low voltage electricity supply line (for example 24 V or less).

Moreover, preferably, the wireless electricity transfer device (that is, the working unit) comprises an impedance transformation network (comprising, for example, a series impedance and/or a parallel capacity) connected to the further electricity supply.

The impedance transformation network is configured in such a way that the further electricity supply has an inlet impedance with a module different to that of the inlet impedance of the control element. This determines a de-adaptation of impedance between the further electricity supply and the relative load; this, surprisingly, has an advantageous effect on the sensitivity of the device.

Moreover, the disclosure also provides an electricity transfer device, having one or more of the features described in this document; in light of this, the right is reserved to protect the electricity transfer device, irrespective of the working units in which it is inserted.

The disclosure also provides a method for contactless electricity transfer in a working unit, comprising a transfer of energy between a stationary electricity supply configured to generate a variable electricity supply with a predetermined frequency, and a working device defining an electrical user device movable relative to the stationary electricity supply.

This method comprises the following steps:
generating a first current circulating in a first winding wound on a stationary core made of ferromagnetic material and connected to the electricity supply;
generating by electromagnetic induction, by the first current, a second current circulating in a second winding connected to the device and wound on a movable core made of ferromagnetic material coupled to the stationary core, to define a contactless electricity supply line of the device.

The method comprises a step of supplying electricity by a control element, movable as one with the device and designed to generate a control signal representing at least one parameter relating to the device.

The control element is powered by a power supply element connected electrically to the control element for powering it in the absence of electricity supply dispensed to the working device.

According to an embodiment, the step of supplying electricity by the control element comprises generating a high frequency variable supply voltage with predetermined trend, by a further electricity supply in the stationary part of the working unit.

According to an embodiment, the step of supplying electricity by the control element comprises dispensing current to the control element by one or more capacitors, or a super capacitor, or one or more batteries, integral with the movable part and connected, for example, to the second winding.

The capacitor (or, more generally, the systems for accumulating electricity interposed between the rectifier and the control element) allows (even in presence of a single contactless electricity supply line) powering the control element without powering the working device, at least temporarily (for example, for a few seconds).

According to another embodiment (alternatively or in addition), the step of supplying electricity to the control element occurs through a further contactless electricity supply line, independent of the contactless electricity supply line of the device.

More specifically, the step of supplying electricity by the control element comprises, for example, circulating a third current in a third winding wound on the core stationary (or, alternatively, on a further stationary ferromagnetic core different from the stationary core on which the first winding is wound) and generating by electromagnetic induction a fourth current in a fourth winding, connected to the control element and wound on the movable core (or, alternatively, on a further movable ferromagnetic core different from the movable core on which the second winding is wound). In that case, the further contactless electricity supply line constitutes a further inductive coupling.

Alternatively or in addition, the step of supplying electricity by the control element comprises generating a variable current at a predetermined frequency different from the electricity supply of the device, circulating in the first winding, and filtering the current circulating in the second winding for selecting a component of current generated by the further electricity supply and supplying it to the control element. In that case, the further contactless electricity supply line uses the same inductive coupling as the (first) contactless electricity supply line.

According to another embodiment, the further contactless electricity supply line constitutes a capacitive coupling.

As regards a step of measuring the parameter relative to the working device, the aim is to provide in the stationary part of the working unit a control signal representing the parameter.

In this context, preferably (in the case wherein the control element is powered by a further contactless electricity supply line), the method comprises a step of processing a control parameter representing a power supply current absorbed by the control element, to derive a control signal representing the parameter relating to the working device, as a function of a trend of the control parameter.

In that way, there is no need to transmit a signal (for example optical, according to another possible solution also included in this description as an alternative embodiment) from the movable part to the stationary part of the working unit, thus simplifying the electronics of the device.

### BRIEF DESCRIPTION OF THE DRAWINGS

This and other features of the disclosure will become more apparent from the following detailed description of a preferred, non-limiting embodiment of it, with reference to the accompanying drawings, in which:

FIG. 1 is a perspective view of a contactless electricity transfer device according to this disclosure;

FIG. 1A illustrates the device of FIG. 1, in a partly open view with a part removed, according to a first embodiment;

FIG. 2 illustrates an exploded view of the device of FIG. 1A;

FIG. 3 schematically illustrates a cross section view of the working unit according to this disclosure, according to the first embodiment;

FIG. 4 shows a general electrical diagram of the working unit of FIG. 3;

FIG. 5 illustrates the working unit of FIG. 3, according to a second embodiment;

FIG. 6 illustrates the working unit of FIG. 3, according to a third embodiment;

FIG. 7 illustrates the working unit of FIG. 3, according to a fourth embodiment.

### DETAILED DESCRIPTION OF PREFERRED EMBODIMENTS OF THE INVENTION

With reference to the accompanying drawings, the working unit 1 has a stationary part 2 and a part 3 movable relative to the stationary part 2.

The movable part 3 moves, in use, relative to the stationary part 2 according to a predetermined path, for example, by rotation, or by translation. Moreover, the movable part 3 comprises a working device 4.

The stationary part 2 comprises an electricity supply 5; the electricity supply 5 is configured to generate a variable supply voltage; preferably, the supply voltage is high-frequency, for example in a range of from 30-250 kHz to 5-20 MHz, or for example in a range of from 30-250 kHz to 10-1000 MHz.

It should also be noted that, preferably, the supply voltage has a square wave form. The electricity supply 5A comprises, for example, an inverter. Preferably, the electricity supply 5A comprises a resonant circuit inverter. That makes it possible to reduce the heat produced and therefore make the working unit 1 particularly efficient. In light of this, it should be noted that the resonant circuit inverter also comprises a filter. This filter is preferably an outlet filter of the inverter configured to reduce the distortion of the current dispensed by the inverter, so as to reduce the electromagnetic pollution produced by the inverter.

Preferably, the working unit 1 comprises a first electricity supply 5A and a second electricity supply 5B; in other words, it comprises, in addition to the electricity supply 5A, a further electricity supply 5B. Hereinafter, reference is made sometimes to electricity supply 5, which includes the (first) electricity supply 5A and (where present), also the further (second) electricity supply 5B.

The working device 4 defines an electrical user device, since, for the relative operation, it must be powered electrically. For example, the working device 4 is a heater (in the example illustrated, a roller heater), or a servo-motor, or a compressor.

It should be noted that the disclosure has many applications; more specifically, power applications.

For example, in the sector of the formation of containers for infusion products (such as, for example, tea, coffee or camomile), use is made of machines with heat-welding stations equipped with corresponding heaters, for example, roller heaters. In this case, the roller heater constitutes the working device 4.

In other possible applications, the working device 4 is a servo-motor mounted on a rotary carousel; applications of this type relate, merely by way of an example, to the sector for the formation of containers for infusion products, or the beverage sector.

The working unit 1 also comprises a contactless electricity transfer device 6; the device 6 is functionally interposed between the electricity supply 5 and the working device 4. The device 6 forms together with the resonant circuit inverter an LC resonant circuit. The device 6 has two secondary ferromagnetic cores (that is, half-cores) 7 and 8 separated by a thin gap 9 so as to be movable relative to each other and a first and a second winding 10, 11 wound on corresponding cores. A current circulating on the first winding generates a magnetic flow circulating in the two secondary cores 7 and 8, which links with the second winding. For this reason, the device 6 transfers electrical power between the first and the second winding, according to the principle of electromagnetic induction, which is typical of transformers; however, thanks to the air gap 9, the two windings are in motion relative to each other. More specifically, the device 6 comprises a stationary core 7, connected to the stationary part 2 of the working unit, and a movable core 8, connected to the movable part 3 of the working unit. The first winding 10 is wound on the stationary core 7 and is connected to the electricity supply 5; the second winding 11 is wound on the movable core 8 and is connected to the device 4 to power it. Preferably, the first winding 10 has a number of turns greater than the number of turns of the second winding 11. For example, the first winding 10 has 27 turns and the second winding 11 has 24 turns (with electricity frequency preferably of 50 kHz); or, the first winding 10 has 18 turns and the second winding 11 has 17 turns (with electricity frequency preferably of 50 kHz).

This enables the device 6 to be made particularly efficient; in effect, the aim is to power the device 6 with the same effective value of voltage required nominally by the user device consisting of the device 4; however, using, preferably, a square wave to power the device 6, it the peak value (of the square wave) is greater than the effective value of the nominal voltage of the user device; in light of this, the fact that the turns ratio between the first and second winding is slightly greater than 1 (preferably within the range [1.05-1.45], more preferably in within the range [1.05-1.15]) compensates this situation. As regards the windings 10, 11 of the device 6, they are made preferably with wires designed to oppose the skin effect and the proximity effect, for example “Litz” wires. This reduces the dissipation of power on the wires themselves and contributes to the efficiency of the device 6.

It should be noted that the stationary core 7 and the movable core 8 are configured in such a way that the electromagnetic coupling (for which a first current circulating in the first winding generates by electromagnetic induction a second current in the second winding) is maintained with the variation of the reciprocal position of the two cores; more specifically, the device 6 is shaped in such a way as to keep the gap 9 constant (unchanged) with respect to the relative movement of the two cores 7, 8. The device 6 constitutes a contactless electricity supply line for the working device 4, which is able to carry electricity to the device 4 from the electricity supply 5 without sliding contacts, by a (first) inductive coupling 11.

The working unit 1 also comprises a control element 12, for controlling the working device 4. The control element 12 is configured for measuring at least one parameter relative to the working device 4.

According to a possible embodiment, the control element 12 is also designed to generate a control signal representing the at least one parameter relating to the working device 4.

Typically, this control element 12 is a sensor, preferably a resistive sensor.

For example, the control element 12 is a temperature sensor (for example, a heat-resistance) or a position or pressure sensor (not illustrated because in itself of known type).

The control element 12 is movable as one with the device 4; in particular, it is connected to the device 4.

In the examples illustrated, the contactless electricity transfer device 6 has a cylindrical symmetry; the movable part 3 of the working unit 1 rotates relative to the stationary part 2 of the working unit 1.

Preferably, the first and second half-core 7, 8 are cup-shaped.

The working unit comprises an electricity supply element 13, connected electrically to the control element 12 for powering it, in the absence of electricity supply dispensed to the working device 4, that is, when the contactless electricity supply line is open, that is, when the electricity supply 5 is disconnected electrically from the working device 4.

The fact that control element 12 can be powered without powering the working device 4 allows, advantageously, powering both the working device 4 and the control element 12 without sliding contacts, and powering the control element 12 even after the device is powered down.

This electricity supply element 13 is integral with the movable part 3 of the working unit. Preferably, the electricity supply element 13 comprises an AC/DC converter having a rectifier 14 (for example, a diode bridge).

According to a preferred embodiment, the working unit 1 comprises a further contactless electricity supply line, independent of the contactless electricity supply line of the working device 4 and defining a wireless connection between the control element 12 and the further electricity supply 5B (which, constructionally, is preferably of the type of the electricity supply 5A described above) in the stationary part 2 of the working unit.

Preferably, the working unit 1 comprises a first contactless electricity supply line L1 and a second contactless electricity supply line L2, which are independent from each other (in the sense that it each may be switched ON or OFF independently of the other).

In order to implement the further contactless electricity supply line there are three embodiments, corresponding to the same number of technical solutions applicable in combination with, or alternatively to, each other.

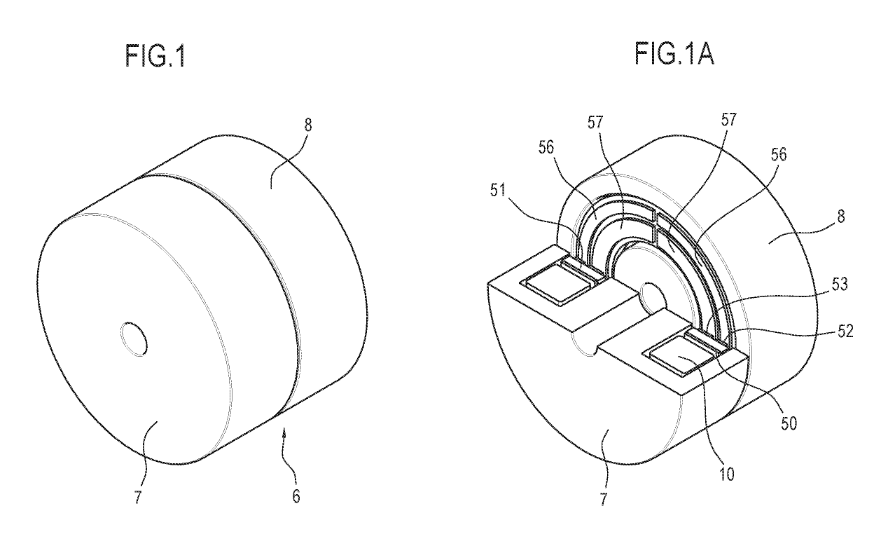

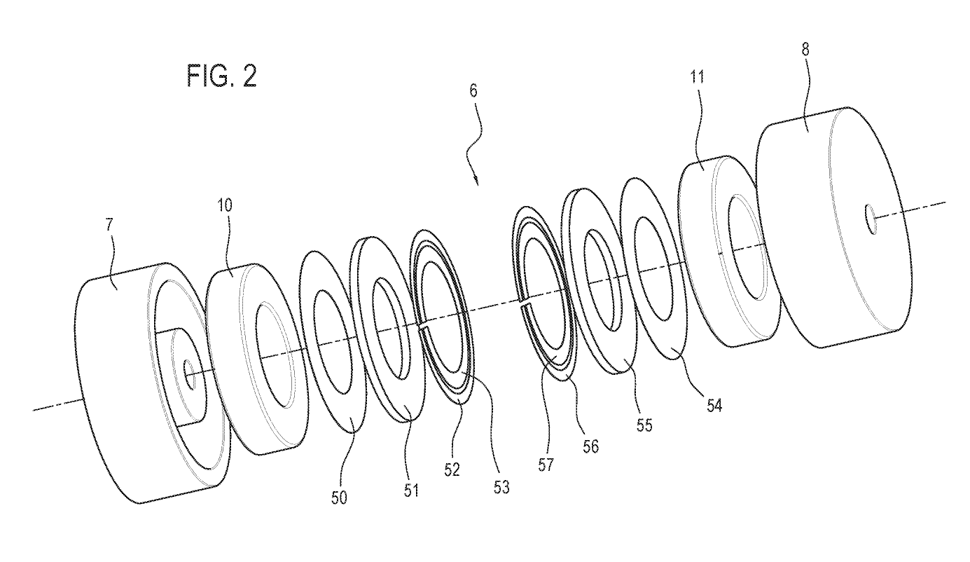

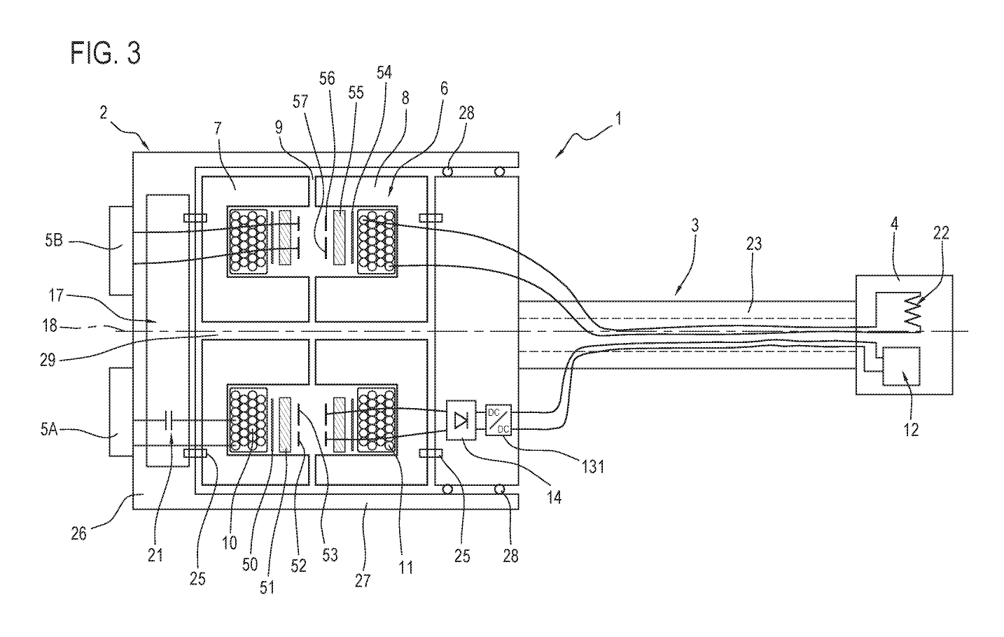

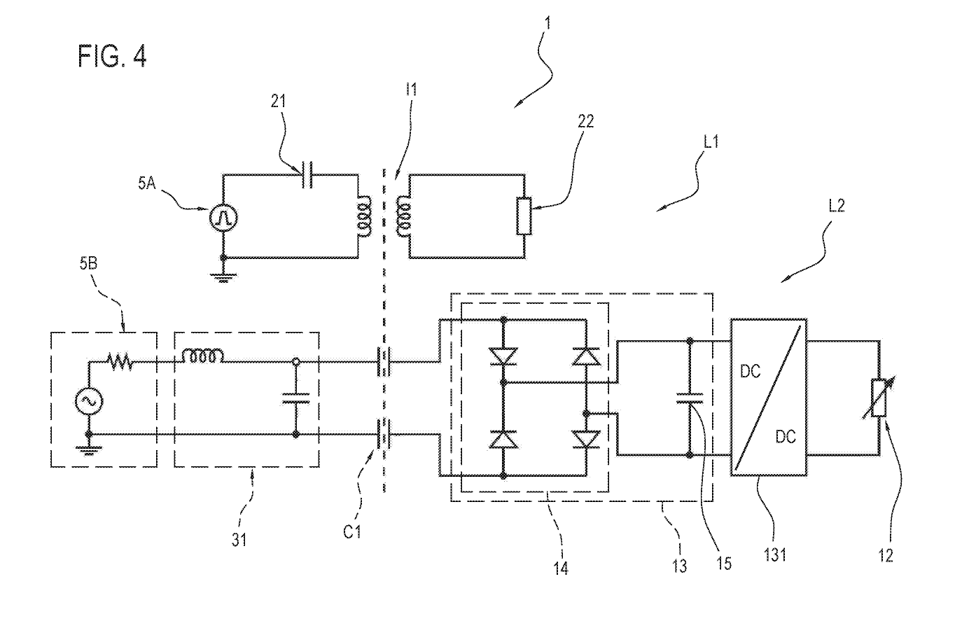

In a first embodiment (illustrated in FIGS. 1A, 2, 3 and 4), the further electricity supply line comprises a capacitive coupling C1.

Preferably, the capacitive coupling C1 comprises a first stationary winding 52 and a second stationary winding 53; and (preferably) a first movable winding 56 and a second movable winding 57. The first stationary winding 52 faces the first movable winding 56 to define a first capacitor; the second stationary winding 53 faces the second movable winding 57 to define a second capacitor. In this regard, it should be noted that the capacitive coupling may become self-resonant coupling, depending on the frequency of the supply voltage.

The first and second stationary winding 52, 53 are connected to the further electricity supply 5B; the first and second movable winding 56, 57 are connected to the control element 12.

Preferably, the rectifier 14 (that is, the AC/DC converter) is interposed between the first and second movable winding 56, 57 and the control element 12.

The first and second stationary winding 52, 53 are interposed between the first winding 10 and the first and second movable winding 56, 57. The first and second movable winding 56, 57 are interposed between the second winding 11 and the first and the second stationary winding 52, 53.

Preferably, the first and second stationary winding 52, 53 and the first and second winding 56, 57 are annular in shape.

Preferably, the first and second stationary winding 52, 53 are co-planar and lie in a first plane; and the first and second movable winding 56, 57 are co-planar and lie in a second plane.

Preferably, the first and second plane are perpendicular to an axis 18 of rotation of the second half-core relative to the first half-core, that is, relative to a cylindrical axis of symmetry of the device 6.

Preferably, the first and second stationary winding 52, 53 are coaxial relative to the axis 18; and the first and second movable winding 56, 57 are also coaxial relative to the axis 18.

Moreover, preferably, the device 6 (that is, the working unit 1) comprises a stationary spacer 51, interposed between the first winding 10 and the first and the second stationary winding 52, 53.

Similarly, the device 6 (that is, the working unit 1) preferably comprises a movable spacer 55, interposed between the second winding 11 and the first and the second movable winding 56, 57.

Preferably, the stationary and movable spacer elements 51 and 55 are made of electrically insulating material, for example glass resin.

Moreover, preferably, the device 6 (that is, the working unit 1) comprises a stationary screen 50, interposed between the first winding 10 and the stationary spacer 51; the stationary screen 50 is in contact with the first winding 10.

Similarly, the device 6 (that is, the working unit 1) preferably comprises a movable screen 54, interposed between the second winding 11 and the movable spacer 55; the movable screen 54 is in contact with the second winding 11.

Preferably, the stationary and movable screens 50 and 54 are made of conductive material, for example aluminium, or copper.

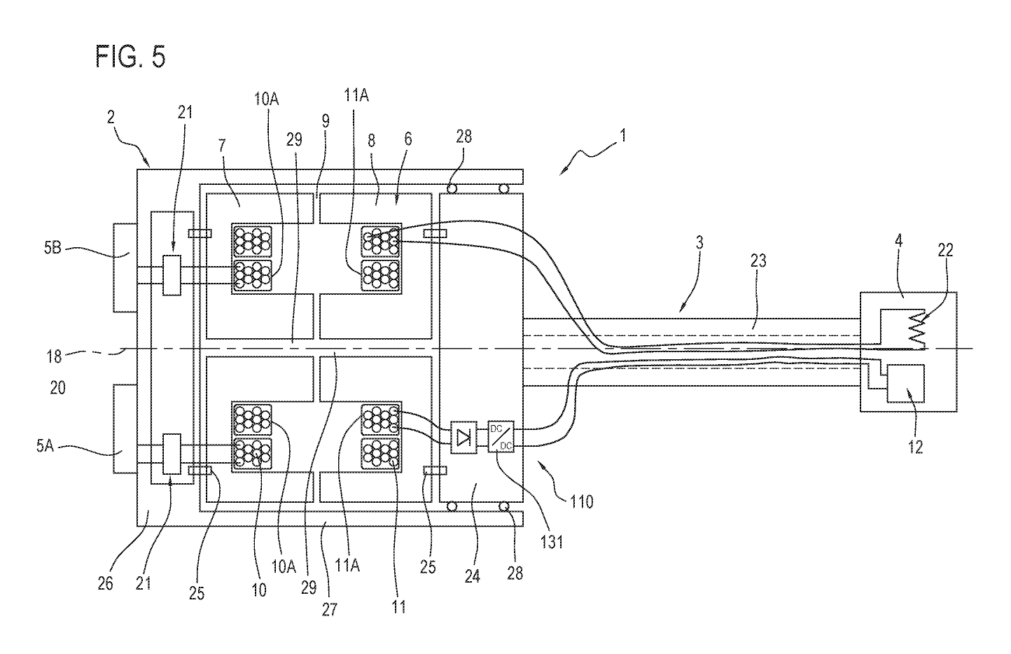

In a second embodiment (illustrated in FIG. 5), the further electricity supply line comprises a third winding 10A, wound on the stationary core 7 and connected to the further electricity supply 5B, and a fourth winding 11A, wound on the movable core 8 and connected to the control element 12 for powering it.

In this case, the working unit 1 comprises, in parallel to the device 6 designed to power the device 4, a second device for contactless electricity transfer designed to power the control element 12.

In other words, the third winding 10A and the fourth winding 11A define a second (further) inductive coupling.

In this solution, the electricity supply element 13 is connected to the fourth winding and may comprise, advantageously, a high pass LC filter, or a high frequency AC/DC converter.

According to a variant not illustrated, the third winding may be wound on a further stationary ferromagnetic core and the fourth winding may be wound on a further movable ferromagnetic core, coupled to the further stationary ferromagnetic core.

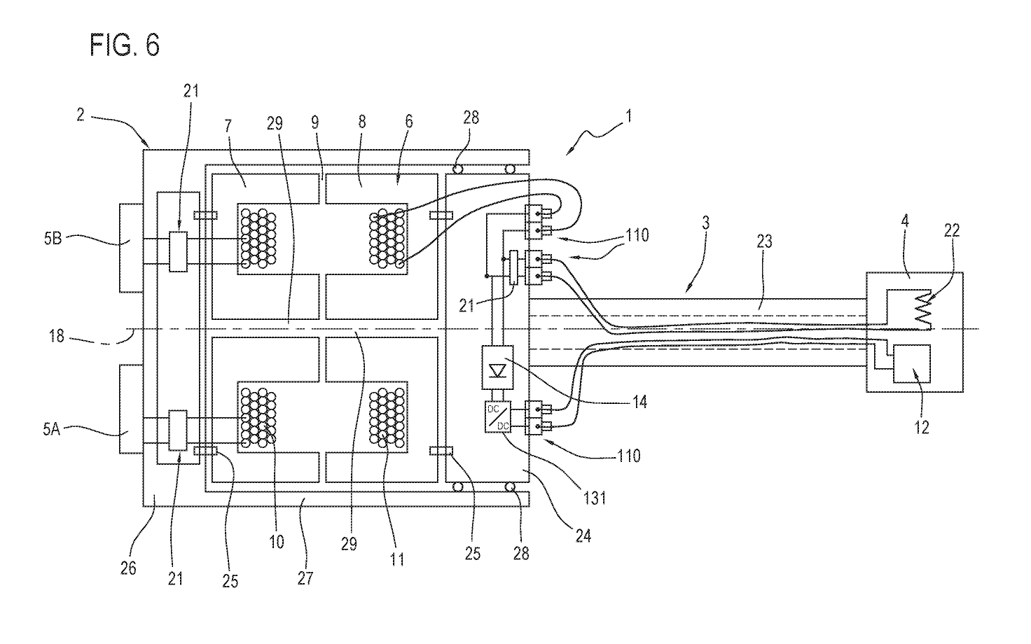

In a third embodiment (illustrated in FIG. 6), the further electricity supply 5B is connected to the first winding 10 and is configured to generate a further alternating supply voltage at a predetermined frequency different from the frequency of the electricity supply 5A of the device 4. In this case, the further electricity supply line comprises a filter connected to the movable part 3 of the working unit and connected to the (downstream of the) second winding 11, upstream of the control element 12, for selecting the current generated by the further electricity supply line and supplying it to the control element 12. In this case, the filter constitutes a closed switch for the current generated by the further electricity supply line and is able to supply the control element 12 irrespective of whether the device 4 is, or is not, powered. In the second solution, the electricity supply element 13 is connected to the second winding 11.

In this embodiment, the control element 12 is electrically connected to the second winding 11. More specifically, the movable part 3 of the working unit comprises terminals 110, connected to the second winding 11. The electrical user device and the control element 12 are connected electrically to the terminals 110.

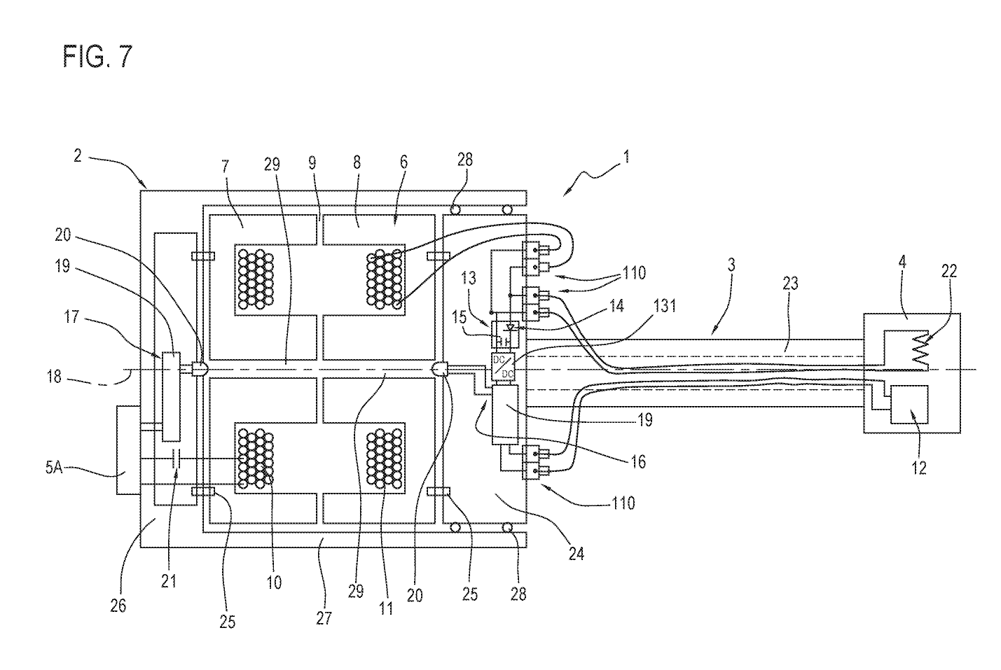

FIG. 7 illustrates a further, fourth embodiment of the disclosure, which does not necessarily presuppose (or even exclude) the presence of the further contactless electricity supply line, as it makes it possible to use a same contactless electricity supply line for powering the control element 12 without powering the working device 4, even if only for a limited period of time.

According to this embodiment, the electricity supply element 13 comprises a capacitor 15 (or a plurality of capacitors). This capacitor 15 is integral with the movable part 3 and is connected to the second winding 11. The capacitor 15 is connected to an outlet of the rectifier 14. Moreover, the electricity supply element 13 is connected in parallel to the second winding 11. Preferably, the capacitor 15 has a relatively high capacitive value (for example, a super capacitor) to guarantee that the control element 12 is powered for a relatively long period of time without the working device 4 being simultaneously powered.

According to another aspect of this description, the device 6 (that is, the working unit 1) is configured for providing the control signal, representing the parameter relating to the working device 4.

In this regard, a first solution comprises processing an electricity supply signal of the control element 12.

This solution is provided in particular in the case in which the control element 12 is powered through the further contactless electricity supply line; and in the case in which the control element 12 is designed to vary a relative electrical property as a function of the parameter relating to the working device 4.

The device 6 (that is, the working unit 1) comprises a processor (not illustrated, consisting, for example, of a processor, or an electronic circuit or a CPU, or other devices designed to process a signal).

The processor is in the stationary part 2 of the working unit 1.

More specifically, preferably, the processor is in a control unit (not illustrated, because in itself of known type, consisting for example of a suitably programmed electronic card); the control unit is integral with the stationary 2 of the working unit 1.

The processor is connected to the further electricity supply 5B to receive a control parameter representing a power supply current absorbed by the control element 12. For example, the control parameter may be a current, a voltage or a power (which may be measured in a node downstream of the further electricity supply 5B, in particular between the further electricity supply 5B and the first winding 10).

The processor is programmed to derive the control signal (representing the parameter relating to the working device 4), as a function of a trend of the control parameter.

In effect, if the wave form of the supply voltage generated by the further feeding 5B is known, the trend of control parameter depends on the load, which consists of the control element 12, which defines a transfer function.

The transfer function of the control element 12 is known (from the manufacturer) as a function of the relative electrical properties, which are variable as a function of the parameters relating to the working device 4.

For this reason, the trend of parameter relating to the working device 4 is derived by the processor as a function of the trend of the control parameter (and of a characteristic of the control element 12 set—preferably just once for all—in a preliminary calibrating step).

In this context, it should be noted that the fact of powering the control element 12 in direct current (due to the presence of the rectifier 14), improves the sensitivity of the device 6 in the measuring of these variations of the control parameter.

In this case, the load of the further electricity supply 5B, given by the control element 12 and by the rectifier 14, is significantly non-linear.

In this context, preferably, the device 6 (that is, the working unit 1) comprises an impedance transformation network 31, connected to the further electricity supply 5B.

The impedance transformation network 31 has the function of varying the inlet impedance of the load seen from the further electricity supply 5B. For example, the impedance transformation network 31 comprises an inductor in series and a capacity in parallel, connected to output terminals of the further electricity supply 5B.

More specifically, the impedance transformation network 31 is configured in such a way that the inlet impedance module of the further electricity supply 5B is different from the inlet impedance module of the control element 12; in other words the impedance transformation network 31 is configured to determine a de-adaptation of impedance in the further contactless electricity supply line L2.

This allows, surprisingly, optimisation of the sensitivity in the measurement of the variations of the parameter relating to the working device 4, depending on the control parameter measured (and processed) by the processor.

More specifically, if the control parameter (representing the power supply current actually dispensed by the further electricity supply 5B) is a voltage (measured downstream of the further electricity supply 5B), preferably the impedance transformation network 31 is configured in such a way that the further electricity supply 5B has an inlet impedance with a module greater than that of the inlet impedance of the control element 12.

If the control parameter is an electrical power (measured downstream of the further electricity supply 5B), preferably, the impedance transformation network 31 is configured in such a way that the further electricity supply 5B has an inlet impedance with a much greater or, alternatively, much lower module than the inlet impedance of the control element 12.

If the control parameter is an electrical current (measured downstream of the further electricity supply 5B), preferably, the impedance transformation network 31 is configured in such a way that the further electricity supply 5B has an inlet impedance with a much smaller module than the inlet impedance of the control element 12.

In a second solution (illustrated in FIG. 7), the control element 12 is configured for transmitting (itself) the control signal to the control unit.

For this purpose, preferably, the working unit 1 comprises an optical transmitter 16 connected to the control element 12 and which is in the movable part 3 of the working unit 1; moreover, the working unit comprises an optical receiver 17, in the stationary part 2, of the working unit 1. The optical transmitter 16 and the receiver 17 are aligned along an unchanging optical path with respect to the relative position of the movable 3 and stationary 2 parts of the working unit 1.

For example, if the movable part 3 is movable relative to the stationary part 2 by translation, the optical path is oriented parallel to the direction of translation.

In this example, the movable part 3 rotates relative to the stationary part 2 about an axis 18 of rotation, along which the optical path is oriented.

It should be noted that each of the optical transmitter 16 and receiver 17 comprises an electronic unit 19 (an electro-optical transducer) and a LED 20. It should be noted that there are two LED 20 (of the optical transmitter 16 and of the receiver 17, respectively) aligned along the optical path.

In this solution, preferably, the electricity supply element 13 is connected to the (and/or integrated in the) electronic unit 19.

According to another aspect of this description, the contactless electricity transfer device 6 comprises, preferably, filtering elements 21 (for example, a capacitor), connected, for example, downstream of the electricity supply 5A and the electricity supply 5B; that is to say, the filtering elements 21 are connected to the first winding 10 (or to the second winding 11) to compensate for a harmonic distortion of the first current (that is, of the current circulating in the first winding 10). Preferably, the filtering elements 21 are connected in series the winding (first 10 and/or second 11).

In the example illustrated, the working device 4 is a thermal welder, in particular a welding roller; the thermal welder is equipped with a heating resistance (heat-resistance) 22 connected to the second winding 11. In light of this, control element 12 comprises a temperature sensor (for example, a heat-resistance).

In this embodiment, the movable core 8 rotates relative to the stationary core 7.

The device 4 (that is, the roller) is connected mechanically to the movable core 8 using a rotary shaft 23 and a rotary flange 24. More specifically, the rotary flange 24 is fixed to the rotary core 8, for example, by screws 25 (or other connecting means).

Therefore, in this embodiment, the movable part 3 of the working unit 1 comprises the welding roller 4, the shaft 23 and the rotary flange 24; the electricity supply unit 13 and the optical transmitter 16 are associated with the rotary flange 24; the control element 12 is associated with the roller 4.

The stationary part 2 of the working unit 1 comprises a cap 26, fixed to the stationary core 7 (for example, by other screws 25 or other fixing means).

The cap 26 defines a cylindrical (annular) wall 27 coaxial with the axis 18 of rotation of the movable part 3 and positioned outside the movable core 8 and the rotary flange 24. The rotary flange 24 is rotatably coupled to the cylindrical wall 27 of the cap 26, for example by bearings 28. The optical receiver 17 is associated with the cap 26.

It should be noted that, in the applications where the stationary and movable parts 2, 3 of the working unit 1 rotate relatively about the axis 18 of rotation, with the stationary and movable cores 7, 8 rotating about the axis 18 of rotation (as in the example illustrated), preferably the stationary and movable cores 7, 8 are cup-shaped.

According to an embodiment (illustrated in FIG. 7), the stationary and movable cores 7, 8 have respective through holes 29, aligned with the axis 18 of rotation; it should be noted that the holes 29 might be filled in whole or in part with a material (optically) transparent, for example an optical guide. In this context, preferably, the optical transmitter 16 and the receiver 17 and, more in particular the corresponding lighting units (for example, the LEDs 20) are positioned at the inlet and outlet of these through holes, facing each other. In other words, in that embodiment, the optical emitter 16 and receiver 17 and, more in particular the corresponding lighting units (for example, the LEDs 20), are aligned along the axis 18 of the through holes 29, opposite the cores 7 and 8. Advantageously, this makes it possible limit overall dimensions of the device 6 and make it particularly reliable.

The disclosure also provides a method for contactless electricity transfer inside the working unit 1.

The method comprises a transfer of electricity between the electricity supply 5 and the working device 4 which is movable relative to the electricity supply 5, which is stationary.

The method comprises the following steps:
generating a first current circulating in the first winding 10, wound on the stationary core 7;
generating by electromagnetic induction, by the first current, a second current circulating in the second winding 11 connected to the device 4 and wound on the movable core 8, the two cores 7, 8 being separated by a gap 9 and configured to form a ferromagnetic structure designed to allow the circulation of a magnetic flow which links with both the windings 10 and 11.

In this way, the device 6 defines a contactless electricity supply line of the device 4.

Preferably, there is a further generation of a high frequency variable supply voltage with predetermined trend, by a further electricity supply 5B in the stationary part 2 of the working unit 1.

Moreover, the method comprises a step for supplying electricity of a control element 12, movable as one with the working device 4.

Preferably, the control element 12 is designed to vary a relative electrical property as a function of a parameter relative to the working device 4.

Preferably, the control element 12 is powered by a further contactless electricity supply line L2, independent of the contactless electricity supply line of the working device 4 and defining a wireless connection between the control element 12 and the further electricity supply 5B.

Alternatively, the control element 12 is powered by means of the contactless electricity supply line L2, using a capacitor 15.

In any case, is possible to power the control element 12 also in the absence of electricity supply dispensed to the working device 4.

Preferably, the method also comprises a step of processing a control parameter representing a power supply current absorbed by the control element 12, to derive a control signal representing the parameter relating to the working device 4, as a function of a trend of the control parameter.

Alternatively, the control element 12 generates the control signal (by means of active electronic components) and transmits it (for example, by an optical transmission system) to the processor associated with the stationary part 2 of the working unit 1.

It should be noted that when the working device 4 is powered by the electricity supply 5 through the device 6, it is also envisaged that the control element 12 is powered by the same device 6 through the electricity supply element 13; on the contrary, when the device 4 is powered down, the control element 12 is powered by the single electricity supply element 13 (whether it consists of the further contactless electricity supply line L2 or it consists of the capacitor 15).

With regard to the step of powering the control element 12 in the absence of electricity supply to the device 4, it is envisaged that the electricity supply element 13 dispenses current to the control element 12; for example through the further contactless electricity supply line L2 (or through the capacitor 15 integral with the movable part 3 and connected to the second winding 11 in parallel through a rectifier 14).

In the case wherein the step of supplying electricity by the control element 12 occurs through the further contactless electricity supply line L2, independent of the contactless electricity supply line of the working device 4, the method further comprises a step of generating a high-frequency current; this current circulates either through the capacitive coupling C1 or through a further inductive coupling; in this latter case, there is a generation of a third current circulating in a third winding 10A wound on the stationary core 7 and the generation by electromagnetic induction, by the third current, of a fourth current circulating in a fourth winding 11A wound on the movable core 8.

Preferably, the current circulating in the further contactless electricity supply line L2, in the movable part 3 of the working unit 1, is subjected to a filtering (for example the fourth current circulating in the fourth winding is filtered), before being supplied to the control element 12. It should be noted that the term “filtering,” in this context means that this current is “cleaned”; moreover, the current circulating in the further contactless electricity supply line L2, in the movable part 3 of the working unit 1 (for example in the fourth winding), induced by the current circulating in the (first) contactless electricity supply line L1, is filtered (by elimination).

Preferably, the first and the second electricity supply 5A and 5B generate voltages at a first and a second frequency different from each other.

In this context, there is also a step of filtering the currents circulating in the two contactless electricity supply lines.

It should be noted that the embodiments in this description do not constitute mutually exclusive technical solutions; in fact, the technical features of the various embodiments can be combined with each other to make further embodiments of the disclosure, which are not described in detail for the sake of brevity but are deemed to be included in this description.

In addition to the above, it should be noted that the following paragraphs, listed in alphanumeric order for reference, are further non-limiting example modes of describing this disclosure.

A. A working unit 1 defining a stationary part 2 and a part 3 movable relative to the stationary part 2, and having a working device 4 in the movable part 3 and forming an electrical user device, an electricity supply 5A, in the stationary part 2 and configured for generating a high frequency variable electricity supply, and a contactless electricity transfer device 6 comprising:
a stationary core 7 made of ferromagnetic material, connected to the stationary part 2 of the working unit;
a first winding 10, wound on the stationary core 7 and connected to the electricity supply 5A;
a movable core 8 made of ferromagnetic material, connected to the movable part 3 of the working unit;
a second winding 11, wound on the movable core 8 and connected to the working device 4 for powering it,
   wherein the stationary and movable cores 7, 8 are coupled, in such a way that a first current circulating in the first winding 10 generates by electromagnetic induction a second current in the second winding 11, so the contactless device 6 for transferring electricity constitutes a contactless electricity supply line L1 of the working device 4;
a control element 12, movable as one with the working device 4, to allow a measurement (in the part stationary 2 of the working unit) of a control signal, representing at least a parameter relating to the device 4;
the control element 12 is connected to the electricity supply 5A or a further electricity supply 5B for being supplied in the absence of electricity supply dispensed to the working device 4.
   A1. The working unit 1 of paragraph A, wherein the control element 12 is designed to vary a relative electrical property as a function of a parameter relative to the working device 4.
   A2. The working unit of paragraph A, or A1, comprising a further electricity supply 5B in the stationary part 2 of the working unit 1 and configured for generating a high frequency variable electricity supply with predetermined trend.
   A3. The working unit 1 of any one of paragraphs A, A1 or A2, comprising a further contactless electricity supply line L2, independent of the contactless electricity supply line of the working device 4 and defining a wireless connection between the control element 12 and the further electricity supply 5B for powering the control element 12 in the absence of electricity supply dispensed to the device 4.
   A4. The working unit 1 of paragraph A3, wherein the further contactless electricity supply line L2 defines a further inductive coupling, relative to the inductive coupling defined by the (first) further contactless electricity supply line L1.
   A5. The working unit 1 of paragraph A4, where the further electricity supply line L2 comprises:
a third winding, wound on the stationary core 7 and connected to the respective electricity supply;
a fourth winding, wound on the movable core 8 and connected to the control element 12 for powering it.
   A6. The working unit 1 of paragraph A3, wherein the further electricity supply is configured to generate a further variable supply voltage at a predetermined frequency different from the frequency of the electricity supply of the device and is connected to the first winding 10, and wherein the further electricity supply line comprises a filter connected to the movable part of the working unit and connected to the second winding 11, upstream of the control element 12, for selecting the current generated by the further electricity supply and supplying it to the control element 12.
   A7. The working unit 1 of paragraph A3 or A6, wherein the further contactless electricity supply line L2 defines a capacitive coupling C1.
   A8. The working unit 1 of any one of paragraphs A to A7, comprising a processor connected to the further electricity supply 5B to receive a control parameter representing a power supply current absorbed by the control element 12, wherein the processor is programmed to derive the control signal representing the parameter relating to the working device 4, as a function of a trend of the control parameter.
   A9. The working unit 1 of any one of paragraphs A to A8, wherein the control element 12 is designed to generate a control signal representing at least one parameter relating to the device 4.
   A10. The working unit 1 of any one of paragraphs A to A9, comprising an electricity supply element 13 connected electrically to the control element 12 for powering it (in the absence of electricity supply dispensed to the working device 4).
   A11. The working unit 1 of paragraph A10, wherein the electricity supply element 13 comprises a rectifier 14.
   A12. The working unit 1 of paragraph A10 or A11 wherein the electricity supply element 13 comprises a capacitor 15.
   A13. The working unit 1 of any one of paragraphs A to A12, comprising an optical transmitter 16 connected to the control element 12 in the movable part 3 of the working unit, and an optical receiver 17 in the stationary part 2 of the working unit, the optical transmitter 16 and receiver 17 being coupled through an optical path positioned along an axis unchanging with respect to the relative position of the movable 3 and stationary 2 parts of the working unit 1.
   A14. The working unit 1 of any one of paragraphs A to A13, wherein the electricity supply 5A (and/or the further electricity supply 5B) comprises a resonant circuit inverter.
   A15. The working unit 1 of any one of paragraphs A to A14, wherein the first winding 10 has a number of turns greater than the number of turns of the second winding 11.
   A16. The working unit 1 of any one of paragraphs A to A15, wherein the working device 4 is a thermal welder equipped with a resistance 22 connected to the second winding 11 and wherein control element 12 comprises a resistive temperature sensor.
   A17. The working unit 1 of any one of paragraphs A to A16, wherein the stationary 2 and movable 3 parts of the working unit 1 rotate relatively about an axis 18 of rotation and wherein the stationary and movable cores 7, 8 can rotate about the axis 18 of rotation.
   A18. The working unit 1 of paragraph A17, wherein the stationary and movable cores 7, 8 are cup-shaped.

1. A working unit defining a stationary part and a part movable relative to the stationary part, and having a working device in the movable part and forming an electrical user device, an electricity supply, in the stationary part and configured for generating a high frequency variable electricity supply, and a contactless electricity transfer device comprising:
a stationary core made of ferromagnetic material, connected to the stationary part of the working unit;
a first winding, wound on the stationary core and connected to the electricity supply;
a movable core made of ferromagnetic material, connected to the movable part of the working unit;
a second winding, wound on the movable core and connected to the working device for powering it,
wherein the stationary and movable cores are coupled, in such a way that a first current circulating in the first winding generates by electromagnetic induction a second current in the second winding, so the contactless device for transferring electricity constitutes a contactless electricity supply line of the working device;
a control element, movable as one with the working device and designed to vary a relative electrical property as a function of a parameter relative to the working device;
the control element is connected to the electricity supply or a further electricity supply for being supplied in the absence of electricity supply dispensed to the working device.

2. The working unit according to claim 1, comprising an electricity supply element connected electrically to the control element for powering it at least temporarily in the absence of electricity supply dispensed to the working device.

3. The working unit according to claim 2, wherein the electricity supply element comprises a rectifier and a DC/DC converter.

4. The working unit according to claim 2, wherein the electricity supply element comprises a capacitor or a battery of capacitors.

5. The working unit according to claim 4, wherein the electricity supply element comprises a rectifier and a DC/DC converter, and wherein the capacitor is connected to an outlet of the rectifier and to an inlet of the DC/DC converter.

6. The working unit according to claim 2, wherein the electricity supply element is directly connected electrically to the electricity supply line and is indirectly connected electrically to the control element to power it at least temporarily in the absence of electricity supply dispensed to the working device.

7. The working unit according to claim 2, wherein the working device is disconnected from the electricity supply element, so that it is excluded from a power supply current dispensed by the electricity supply element.

8. The working unit according to claim 1, comprising:
a further electricity supply in the stationary part of the working unit and configured for generating a high frequency variable electricity supply with predetermined trend;
a further contactless electricity supply line, independent of the contactless electricity supply line of the working device and defining a wireless connection between the control element and the further electricity supply for powering the control element in the absence of electricity supply dispensed to the device;
a processor connected to the further electricity supply to receive a control parameter representing a power supply current absorbed by the control element, wherein the processor is programmed to derive a control signal representing the parameter relating to the working device, as a function of a trend of the control parameter.

9. The working unit according to claim 8, comprising an impedance transformation network connected to the further electricity supply and configured in such a way that the further electricity supply has an inlet impedance with a module different to that of the inlet impedance of the control element, or different from the inlet impedance of the rectifier element inserted in the further contactless electricity supply line, for powering the control element with a direct current.

10. The working unit according to claim 9, wherein
the control parameter representing the power supply current actually dispensed by the further electricity supply is a voltage measured downstream of the further electricity supply, and the further electricity supply has an inlet impedance with a module greater than the inlet impedance of the control element; or wherein
the control parameter representing the power supply current actually dispensed by the further electricity supply is an electrical power measured downstream of the further electricity supply, and the further electricity supply has an inlet impedance with a module much greater or much less than the inlet impedance of the control element; or wherein
the control parameter representing the power supply current actually dispensed by the further electricity supply is a current measured downstream of the further electricity supply, and the further electricity supply has an inlet impedance with a module much less than the inlet impedance of the control element.

11. The working unit according to claim 8, wherein the electricity supply delivers a supply voltage at a first frequency and the further electricity supply delivers a supply voltage at a second frequency different from the first.

12. The working unit according to claim 8, wherein the further contactless electricity supply line comprises a capacitive coupling.

13. The working according to claim 12, wherein the capacitive coupling comprises a first and a second stationary winding, and a first and a second movable winding, wherein the first stationary winding faces the first movable winding to define a first capacitor and the second stationary winding faces the second movable winding to define a second capacitor, and wherein the first and second stationary winding are interposed between the first winding and the first and second movable winding, and the first and the second movable winding are interposed between the second winding and the first and second stationary winding.

14. The working unit according to claim 13, comprising:
a stationary spacer, made of electrically insulating material, interposed between the first winding and the first and the second stationary winding;
a stationary screen, made of conductive material, interposed between the first winding and the stationary spacer;
a movable spacer, made of electrically insulating material, interposed between the second winding and the first and the second movable winding;
a movable screen, made of conductive material, interposed between the second winding and the movable spacer.

15. The working unit according to claim 8, wherein the further electricity supply line comprises:
a third winding, wound on the stationary core and connected to the further electricity supply;
a fourth winding, wound on the movable core and connected to the control element for powering it.

16. The working unit according to claim 8, where the working device is disconnected from the further contactless electricity supply line, so it is excluded from a power supply current dispensed by the further contactless electricity supply line.

17. The working unit according to claim 1, wherein the contactless electricity transfer device has a cylindrical symmetry and the movable part of the working unit rotates relative to the stationary part of the working unit.

18. The working unit according to claim 1, wherein the control element is a position sensor or transducer.

19. The working unit according to claim 1, wherein the device comprises a heater, or a servomotor, or a compressor.

20. The working unit according to claim 1, wherein the device is a hot welder and the control element is a temperature sensor.

21. A method for contactless electricity transfer in a working unit, comprising a transfer of energy between a stationary electricity supply configured to generate a high frequency variable electricity supply, and a working device defining an electrical user device movable relative to the electricity supply, by means of the following steps:
generating a first current circulating in a first winding wound on a stationary core made of ferromagnetic material and connected to the electricity supply;
generating by electromagnetic induction, by the first current, a second current circulating in a second winding connected to the working device and wound on a movable core made of ferromagnetic material coupled to the stationary core, to define a contactless electricity supply line of the working device,
supplying electricity to a control element, movable as one with the working device and designed to vary a relative electrical property as a function of a parameter relative to the working device, through the electricity supply or a further electricity supply, in the absence of electricity supply dispensed to the working device.

22. The method according to claim 21, wherein the electricity supply of the control element comprises a dispensing of current to the control element by an electricity supply element which rectifies a current to be dispensed to the control element and performs a DC/DC conversion.

23. The method according to claim 22, comprising a step of storing, at least temporarily, electricity dispensed by the electricity supply element.

24. The method according to claim 21, comprising the following steps:
generating a high frequency variable supply voltage with predetermined trend, by a further electricity supply in the stationary part of the working unit;
electricity supply of the control element by means of a further contactless electricity supply line, independent of the contactless electricity supply line of the working device and defining a wireless connection between the control element and the further electricity supply, so that the control element may be powered in the absence of electricity supply dispensed to the device;
processing a control parameter representing a power supply current absorbed by the control element, to derive a control signal representing the parameter relating to the working device, as a function of a trend of the control parameter.

25. The method according to claim 21, wherein the electricity supply of the control element is independent of the electricity supply of the working device, so as to be able top power the control element without powering the working device.
